(19) United States
(12) Patent Application Publication
(10) Pub. No.: US 2016/0140583 A1
(43) Pub. Date: May 19, 2016

(54) DYNAMIC ENSEMBLE MODELING FOR REVENUE FORECASTING

(71) Applicant: International Business Machines Corporation, Armonk, NY (US)

(72) Inventors: Yasuo Amemiya, Hartsdale, NY (US); Konstantin Anikeev, Brookfield, CT (US); Hongxia Yang, Pleasantville, NY (US)

(21) Appl. No.: 14/541,352

(22) Filed: Nov. 14, 2014

(51) Int. Cl. G06Q 30/02

(52) U.S. Cl. CPC G06Q 30/0202

(57) ABSTRACT

In an approach to revenue forecasting, one or more computer processors retrieve revenue forecast data. The one or more computer processors process the revenue forecast data through one or more revenue forecast models. The one or more computer processors retrieve one or more weights associated with a performance of the one or more revenue forecast models, where each of the one or more weights corresponds to one of the one or more revenue forecast models. The one or more computer processors apply one of the one or more weights associated with the performance of the one or more revenue forecast models to each of a corresponding processed revenue forecast data. The one or more computer processors compute a weighted average revenue forecast.

### BACKGROUND OF THE INVENTION

The present invention relates generally to the field of data modeling, and more particularly to data modeling for revenue forecasting.

Revenue forecasts are the foundation of many companies' business plans. Accurate forecasts enable a company to evaluate current business performance, set appropriate sales targets, create effective marketing promotion mixes, build expense budgets, and manage sales staff. Revenue forecasts for an enterprise are typically issued for different units of business in a consistent manner. For units organized in a hierarchical way, a forecast for a unit is the aggregation of forecasts for all sub-units just below the target unit. This hierarchical rollup structure can be represented by qualitative dimensions, for example, region, product, or customer set. Forecasting models typically use quantitative measures available at each unit, and issue numerical forecasts that can be aggregated or sliced based on the qualitative dimension.

Typically, revenue forecasts for a targeted period of reference, such as quarterly revenue, are provided periodically, such as every week during the quarter, to management and shareholders. Periodic revenue forecasts are typically used internally in large companies to evaluate, assess, and possibly enact change. In many cases, such change may be desired so that the quarterly or other periodic revenue assessment will be more favorable. As such, revenue forecasts are generally computed at more than one point during the quarter or other period of reference, and continue to be repeated in the same way once the next period of reference begins.

### SUMMARY

Embodiments of the present invention disclose a method, a computer program product, and a system for revenue forecasting. The method may include one or more computer processors retrieving revenue forecast data. The one or more computer processors process the revenue forecast data through one or more revenue forecast models. The one or more computer processors retrieve one or more weights associated with a performance of the one or more revenue forecast models, where each of the one or more weights corresponds to one of the one or more revenue forecast models. The one or more computer processors apply one of the one or more weights associated with the performance of the one or more revenue forecast models to each of a corresponding processed revenue forecast data. The one or more computer processors compute a weighted average revenue forecast.

### BRIEF DESCRIPTION OF THE SEVERAL VIEWS OF THE DRAWINGS

FIG. 1 is a functional block diagram illustrating a distributed data processing environment, in accordance with an embodiment of the present invention;

FIG. 2 is a flowchart depicting operational steps of a quarterly weight update program, on a server computer within the distributed data processing environment of FIG. 1, for updating the weights of elements used in revenue forecast calculations, in accordance with an embodiment of the present invention;

FIG. 3 is a flowchart depicting operational steps of a weekly forecast issuance program, on a server computer within the distributed data processing environment of FIG. 1, for generating an ensemble revenue forecast, in accordance with an embodiment of the present invention; and

FIG. 4 depicts a block diagram of components of the server computer executing the quarterly weight update program and the weekly forecast issuance program within the distributed data processing environment of FIG. 1, in accordance with an embodiment of the present invention.

### DETAILED DESCRIPTION

Revenue forecasting accuracy requirements are increasing for companies, or enterprises, to successfully compete in the marketplace and improve the ability to make accurate near- and mid-term management decisions. At an enterprise with a hierarchical business unit structure, each unit throughout the organizational structure needs to issue revenue forecasts accurately and consistently. There is often difficulty combining multiple forecasts from heterogeneous data sources. For repeatedly issued forecasting of a target quantity to take advantage of real-time updates to the information, there may be additional difficulty in assuring a smooth transition of forecasts over time. Therefore, there is a need to balance between accuracy and smoothness of the data.

Embodiments of the present invention recognize that revenue forecasting can be improved by dynamic ensemble modeling. Utilizing performance-based weighting to combine forecast results from a plurality of forecast models and incorporating data smoothing techniques may improve the accuracy of revenue forecasting over conventional methods. Implementation of embodiments of the invention may take a variety of forms, and exemplary implementation details are discussed subsequently with reference to the Figures.

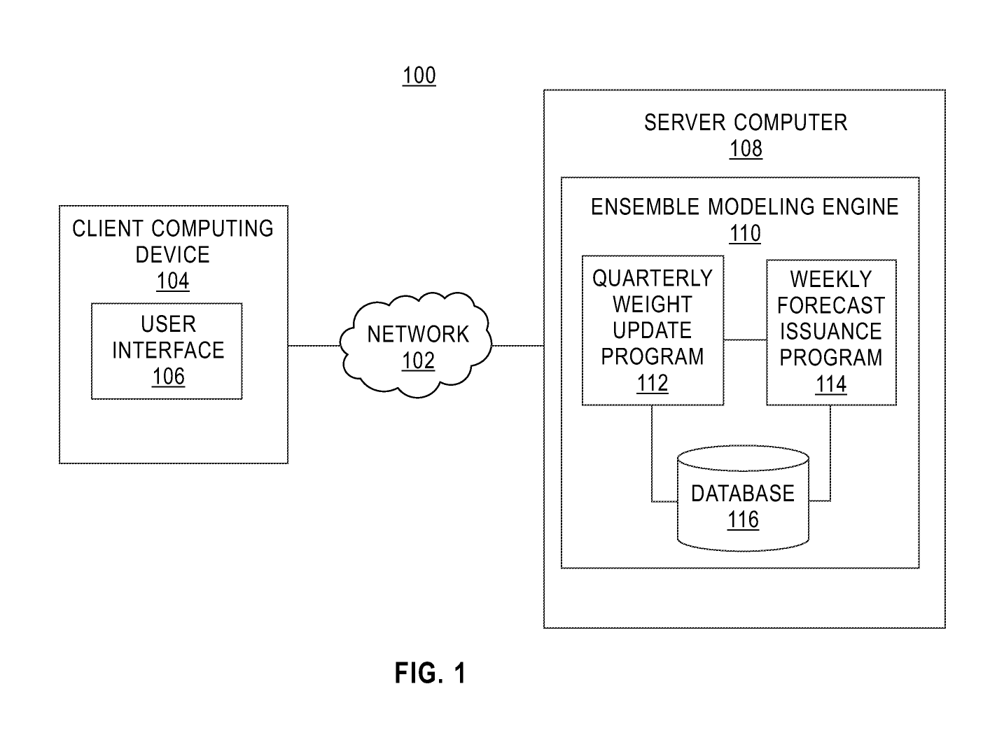

FIG. 1 is a functional block diagram illustrating a distributed data processing environment, generally designated 100, in accordance with one embodiment of the present invention. In an exemplary embodiment, distributed data processing environment 100 represents an enterprise structure environment. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes client computing device 104 and server computer 108, interconnected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks that are capable of receiving and transmitting data, voice, and/or video signals, including multimedia signals that include voice, data, and video information.

Client computing device 104 can be a desktop computer, a laptop computer, a tablet computer, a specialized computer server, a smart phone, or any programmable electronic device capable of communicating with server computer 108 via network 102 and with various components and devices within distributed data processing environment 100. In general, client computing device 104 represents any programmable electronic device or combination of programmable electronic devices capable of executing machine readable program instructions and communicating with other computing devices via a network, such as network 102. Client computing device 104 includes user interface 106.

User interface 106 provides an interface between a user of client computing device 104 and server computer 108. User interface 106 may be a graphical user interface (GUI) or a web user interface (WUI) and can display text, documents, web browser windows, user options, application interfaces, and instructions for operation, and includes the information (such as graphic, text, and sound) that a program presents to a user and the control sequences the user employs to control the program. User interface 106 may also be mobile application software that provides an interface between a user of client computing device 104 and server computer 108. Mobile application software, or an “app”, is a computer program designed to run on smart phones, tablet computers and other mobile devices. User interface 106 enables a user of client computing device 104 to retrieve or receive revenue forecasts from server computer 108.

Server computer 108 can be a management server, a web server, or any other electronic device or computing system capable of receiving and sending data. In other embodiments, server computer 108 can represent a server computing system utilizing multiple computers as a server system, such as in a cloud computing environment. In another embodiment, server computer 108 can be a laptop computer, a tablet computer, a netbook computer, a personal computer (PC), a desktop computer, a personal digital assistant (PDA), a smart phone, or any programmable electronic device capable of communicating with client computing device 104 via network 102. In another embodiment, server computer 108 represents a computing system utilizing clustered computers and components to act as a single pool of seamless resources. Server computer 108 includes ensemble modeling engine 110.

Ensemble modeling engine 110 utilizes a suite of revenue forecasting models, referred to as sub-models, to generate an ensemble forecast. The combination of the sub-models in the suite covers each of the relevant business units in an enterprise structure. Typically, data exists at multiple levels of an enterprise. An example of the multiple levels at which large enterprises operate and maintain data is by geographic region, where some high-level summaries are maintained (such as by continent or other large geographical area) as well as lower-level summaries (e.g. by country, geography, or region). In addition to the geographical definition of revenue-related data, enterprises often maintain information at different product levels, such as by brand, group, line of business, etc., from a high-level description to a finer-grained set of data (e.g. by specific product line versus by some regrouping of several products and/or services). The combination of the sub-models also covers each forecasting issuing period, for example, daily, weekly, monthly, and quarterly. Ensemble modeling engine 110 employs weighted averages on the results of the various sub-models based on past performance as compared to actual results to improve the accuracy of the revenue forecast. Ensemble modeling engine 110 may also eliminate outliers from the data to improve the smoothness of the forecast over time. Outliers are data that are well outside the expected range of values. Ensemble modeling engine 110 includes quarterly weight update program 112, weekly forecast issuance program 114, and database 116.

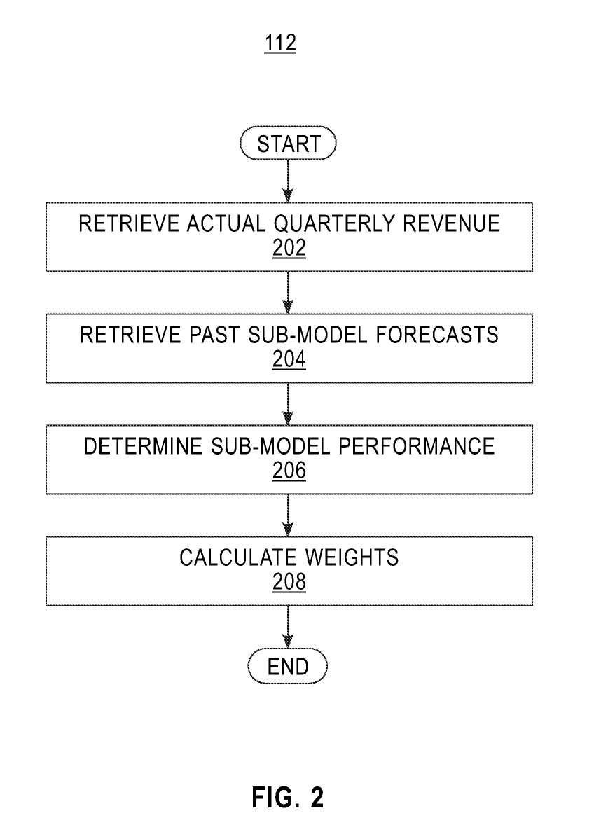

Quarterly weight update program 112 compares past sub-model forecast predictions to past actual results in order to determine the performance and accuracy of the sub-models. In one embodiment, quarterly weight update program 112 uses past actual quarterly results. In another embodiment, quarterly weight update program 112 uses actual results based on a different time frequency, for example monthly. Based on the determination of the sub-models' performance and accuracy as compared to actual results, quarterly weight update program 112 assigns weights to the revenue forecast results of various sub-models for use in an ensemble forecast computation. Quarterly weight update program 112 is depicted and described in further detail with respect to FIG. 2.

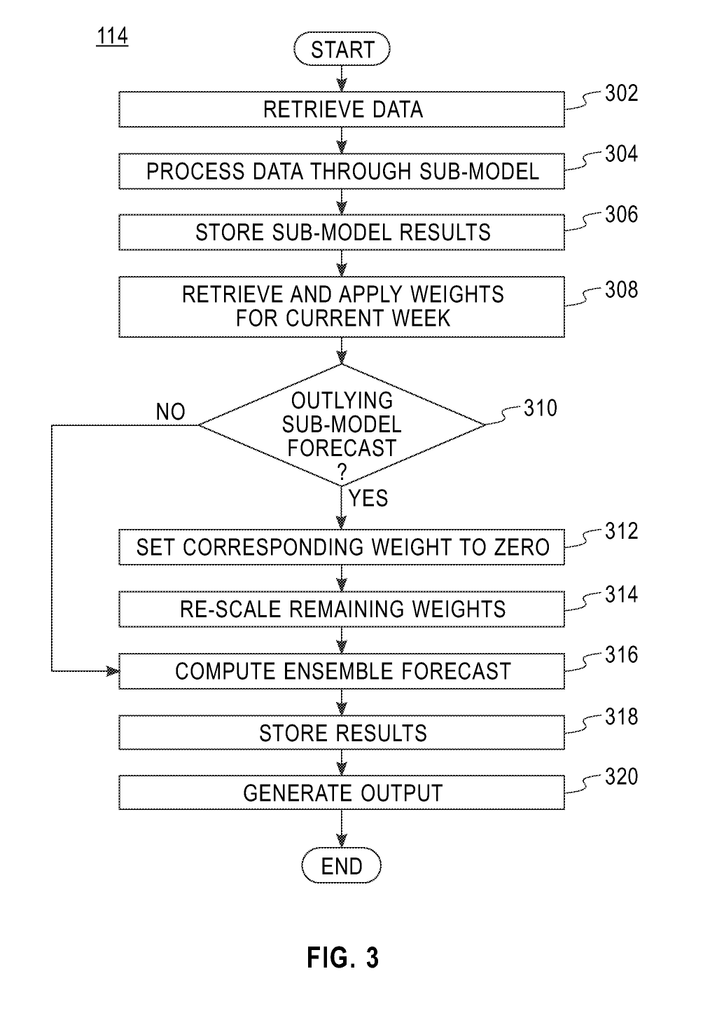

Weekly forecast issuance program 114 computes the ensemble revenue forecast by retrieving current forecast data, processing the data through one or more of the forecast sub-models, and applying the weights calculated by quarterly weight update program 112 to the results of each sub-model. Weekly forecast issuance program 114 determines whether any of the sub-model forecasts appears to be an outlier and applies a zero weight factor to outlier data. After re-scaling the weights of the remaining sub-models, weekly forecast issuance program 114 computes an ensemble revenue forecast. In one embodiment, weekly forecast issuance program 114 dynamically updates the ensemble forecast weekly. In another embodiment, weekly forecast issuance program 114 may dynamically update the ensemble forecast at a different frequency, for example, monthly. Weekly forecast issuance program 114 is depicted and described in further detail with respect to FIG. 3.

Database 116 resides on server computer 108. In another embodiment, database 116 can reside elsewhere in distributed data processing environment 100. A database is an organized collection of data. Database 116 can be implemented with any type of storage device capable of storing data that can be accessed and utilized by server computer 108, such as a database server, a hard disk drive, or a flash memory. In other embodiments, database 116 can represent multiple storage devices within server computer 108. Database 116 includes one or more sub-models for calculating revenue forecasts and the results generated by the one or more sub-models' calculations. In another embodiment, one or more sub-models for calculating revenue forecasts reside separately on server computer 108. In a further embodiment, one or more sub-models for calculating revenue forecasts may reside elsewhere in distributed data processing environment 100, provided that results generated by the one or more sub-models can be accessed by quarterly weight update program 112 and weekly forecast issuance program 114. Database 116 stores the weight calculations generated by quarterly weight update program 112. Database 116 also stores the ensemble forecasts generated by weekly forecast issuance program 114. In addition, database 116 also stores past actual revenue data.

FIG. 2 is a flowchart depicting operational steps of quarterly weight update program 112, on server computer 108 within distributed data processing environment 100 of FIG. 1, for updating the weights of elements used in revenue forecast calculations, in accordance with an embodiment of the present invention.

Quarterly weight update program 112 retrieves actual quarterly revenue (step 202). In an embodiment, at the conclusion of a quarter, each business unit within the enterprise calculates and stores the actual quarterly revenue results with previous revenue history in database 116. In one embodiment, a business unit calculates and stores the actual quarterly revenue results on the final day of the quarter. In another embodiment, a business unit calculates and stores the actual quarterly revenue results within two weeks of the final day of the quarter. Quarterly weight update program 112 retrieves the actual revenue data from database 116 for comparison to the forecast for that period. For example, at the beginning of April, the actual revenue results from the first quarter, comprised of January, February, and March, are calculated based on data such as actual sales in that period, and stored in database 116. Quarterly weight update program 112 retrieves the data from database 116.

Quarterly weight update program 112 retrieves past sub-model forecasts (step 204). A suite of forecasting sub-models is used to forecast revenue for various elements of the enterprise structure. Examples of elements of the enterprise structure include geography and line of business. Forecast data from each of the sub-models is stored in database 116 at a frequency associated with each particular sub-model. For example, some sub-models may be run weekly, while others may be run monthly, quarterly, or at other varying time increments. Quarterly weight update program 112 retrieves the updates to the sub-model revenue forecast results from the previous quarter from database 116.

Quarterly weight update program 112 determines sub-model performance (step 206). Quarterly weight update program 112 compares the actual quarterly revenue results to the sub-model forecasts for the same period to determine the performance, or accuracy, of the sub-models. The smaller the difference between a sub-model forecast and the actual results, the higher the performance of the sub-model, leading to a relatively larger weight. For example, the value of the difference between a sub-model forecast and the actual results that is least, when compared to all of the differences, implies the highest accuracy. Quarterly weight update program 112 compares the performance of the sub-models for each business unit and for each time period. When actual quarterly revenue results become available in database 116, quarterly weight update program 112 uses the results to calculate weights for use in the following quarter.

Quarterly weight update program 112 calculates weights (step 208). Quarterly weight update program 112 calculates a unique weight for each element of the enterprise structure and for each forecast issuing time period based on the historical performance of the sub-model. Quarterly weight update program 112 calculates a set of weights for weekly forecast issuance program 114 to use for the sub-models in each of the 13 weeks of the current quarter. The sum of the weights of each of the sub-models equals one. For example, quarterly weight update program 112 calculates weights for sub-model A for week 1, week 2, etc., through week 13, and does the same for each sub-model in the suite. Those of ordinary skill in the art may calculate a weight proportional to a reciprocal of a quantitative performance measure such as mean squared prediction error for a specific week. Quarterly weight update program 112 uses performance measure values in multiple weeks and applies a smoothing technique to the values such that the calculated weights are similar over neighboring weeks. In one embodiment, for each week, quarterly weight update program 112 applies a kernel smoothing technique to ensure the stability of the weights over the weeks. For example, the kernel smoothing technique applies a bell curve over the performance measure values over weeks to obtain smoothed measure values. Then, the weights calculated proportionally to the smoothed performance measure values appear stable over neighboring weeks. By introducing smoothing to the calculation, resulting revenue forecasts are less volatile and better aid business planning.

FIG. 3 is a flowchart depicting operational steps of weekly forecast issuance program 114, on server computer 108 within distributed data processing environment 100 of FIG. 1, for generating an ensemble revenue forecast, in accordance with an embodiment of the present invention.

Weekly forecast issuance program 114 retrieves data (step 302). Weekly forecast issuance program 114 retrieves available forecast data from database 116. The available forecast data may include data from all elements of the enterprise structure. Many elements of the enterprise structure store data at different frequencies and time intervals. For example, some elements of the enterprise structure may store updated forecast data on a weekly basis, while others may store updated forecast data on a monthly or quarterly basis. Weekly forecast issuance program 114 retrieves the data on a weekly basis for a given weekly update, even if some values are the same as the previous week because the data is not updated weekly. In one embodiment, database 116 is set up to send data to weekly forecast issuance program 114 automatically, as soon as the data becomes available. For example, if some forecast data is available on a daily basis, weekly forecast issuance program 114 may receive the data every day instead of retrieving the data on a weekly basis.

Weekly forecast issuance program 114 processes data through the sub-models (step 304). As discussed earlier, a suite of sub-models exists within ensemble modeling engine 110 for calculating revenue forecasts. Weekly forecast issuance program 114 processes the retrieved data through the one or more sub-models to produce the sub-model forecast results for the current week. Some of the sub-model forecast results may be the same as the previous week if the data for a particular sub-model does not change weekly.

Weekly forecast issuance program 114 stores the sub-model results (step 306). Responsive to processing the retrieved data through the sub-models, weekly forecast issuance program 114 stores the sub-model forecast results in database 116. If the stored results are from sub-models that are not updated on a weekly basis, then weekly forecast issuance program 114 may use the stored results in the following week.

Weekly forecast issuance program 114 retrieves and applies weights for the current week (step 308). As discussed earlier, with respect to FIG. 2, quarterly weight update program 112 calculates a weight for each sub-model for each week of the current quarter. Weekly forecast issuance program 114 retrieves the weights from database 116 and applies weights to the current results from the respective sub-models.

Weekly forecast issuance program 114 determines if there is an outlying sub-model forecast (decision block 310). Weekly forecast issuance program 114 analyzes the sub-model forecast results, and determines whether any of the results are unusual or are outside of what is expected. For example, if sub-model forecast A deviates considerably from other sub-model forecasts, or from previous sub-model A forecasts, then sub-model forecast A is considered an outlier. If weekly forecast issuance program 114 determines that one or more of the sub-model forecast results are outliers (“yes” branch, decision block 310), then weekly forecast issuance program 114 sets the corresponding weights of the outlier sub-model forecasts to zero (step 312). For the purpose of maintaining the accuracy of the ensemble forecast, weekly forecast issuance program 114 sets the weight of any sub-model outlier forecast to zero such that the outlier forecasts are not included in the final ensemble forecast computation. The removal of the outliers may reduce the volatility of the ensemble forecast.

Weekly forecast issuance program 114 re-scales the remaining weights (step 314). With one or more of the sub-model forecasts set to a zero weight, weekly forecast issuance program 114 re-scales the weights of the remaining sub-model forecasts such that the sum of the resulting weights equals one. In one embodiment, the weights are equivalent to confidence percentages. For example, if three sub-models are used, the corresponding weights may be 0.23, 0.13, and 0.64. If the sub-model for which the weight is 0.23 is determined to be an outlier, then the 0.23 weight is set to zero. Then weekly forecast issuance program 114 re-scales the remaining two weights proportionally, using techniques known in the art, such that the sum of the two weights equals one.

Responsive to setting the weight of any outlier sub-model forecasts to zero and re-scaling the remaining forecasts, or if weekly forecast issuance program 114 determines that there are no sub-model forecast outliers (“no” branch, decision block 310), then weekly forecast issuance program 114 computes an ensemble forecast (step 316). Weekly forecast issuance program 114 computes a final revenue forecast by applying the weights to the sub-model forecasts and forming a weighted average of the sub-model forecasts. Weekly forecast issuance program 114 may compute a separate ensemble forecast for each element of the enterprise structure. Weekly forecast issuance program 114 provides accuracy to the ensemble revenue forecast by applying smoothing techniques, such as removing the outlier sub-model forecasts, as discussed with respect to step 312.

Weekly forecast issuance program 114 stores the results (step 318). Responsive to computing the ensemble forecast, weekly forecast issuance program 114 stores the results of the computation in database 116. Weekly forecast issuance program 114 stores the sub-model results for use by quarterly weight update program 112. In addition, weekly forecast issuance program 114 may use the results of the ensemble forecast, including the weights applied to the various sub-models and outlier indications, in future forecast computations, therefore weekly forecast issuance program 114 stores the data.

Weekly forecast issuance program 114 generates output (step 320). Weekly forecast issuance program 114 generates output of the ensemble revenue forecast for use by enterprise management. For example, weekly forecast issuance program 114 generates a report that lists the current week ensemble forecast by enterprise element. In another example, weekly forecast issuance program 114 may generate a report that compares the current week forecast to the past week forecast and indicates any significant changes. In one embodiment, weekly forecast issuance program 114 automatically sends a report to a distribution list each week. In another embodiment, a user of client computing device 104 may retrieve a report from weekly forecast issuance program 114 via user interface 106.

In an embodiment where weekly forecast issuance program 114 receives data automatically, as the data becomes available, weekly forecast issuance program 114 may return to step 302 responsive to receiving updated data.

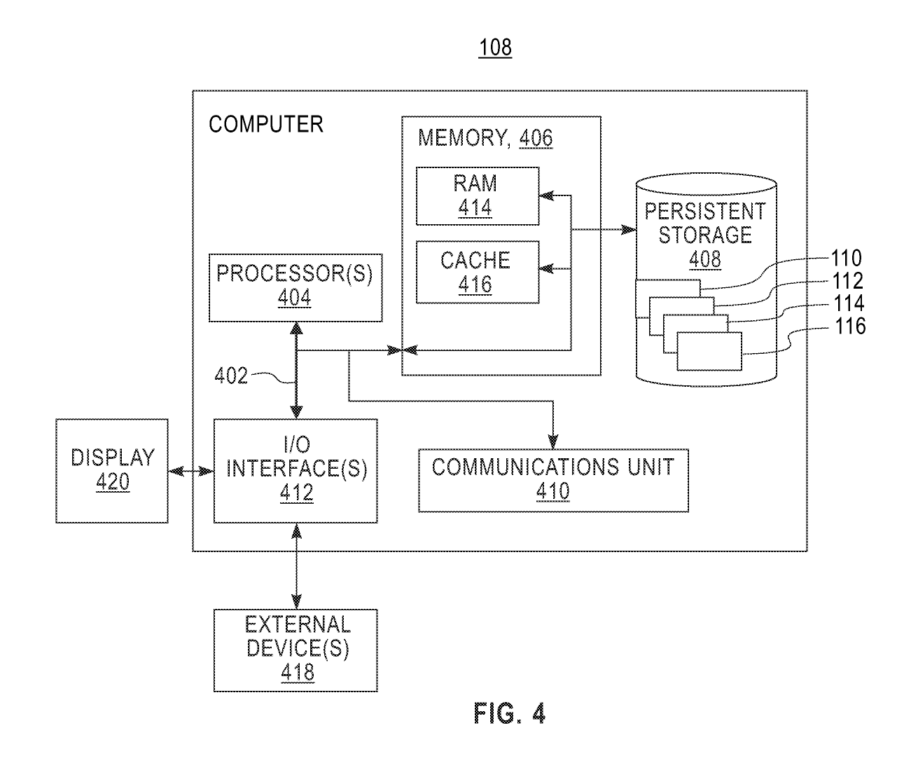

FIG. 4 depicts a block diagram of components of server computer 108 executing quarterly weight update program 112 and weekly forecast issuance program 114 within distributed data processing environment 100 of FIG. 1, in accordance with an embodiment of the present invention. It should be appreciated that FIG. 4 provides only an illustration of one implementation and does not imply any limitations with regard to the environments in which different embodiments can be implemented. Many modifications to the depicted environment can be made.

Server computer 108 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM) 414 and cache memory 416. In general, memory 406 can include any suitable volatile or non-volatile computer readable storage media.

Ensemble modeling engine 110, quarterly weight update program 112, weekly forecast issuance program 114, and database 116 are stored in persistent storage 408 for execution and/or access by one or more of the respective computer processor(s) 404 via one or more memories of memory 406. In this embodiment, persistent storage 408 includes a magnetic hard disk drive. Alternatively, or in addition to a magnetic hard disk drive, persistent storage 408 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices, including resources of client computing device 104. In these examples, communications unit 410 includes one or more network interface cards. Communications unit 410 may provide communications through the use of either or both physical and wireless communications links. Ensemble modeling engine 110, quarterly weight update program 112, weekly forecast issuance program 114, and database 116 may be downloaded to persistent storage 408 through communications unit 410.

I/O interface(s) 412 allows for input and output of data with other devices that may be connected to server computer 108. For example, I/O interface(s) 412 may provide a connection to external device(s) 418 such as a keyboard, a keypad, a touch screen, a microphone, a digital camera, and/or some other suitable input device. External device(s) 418 can also include portable computer readable storage media such as, for example, thumb drives, portable optical or magnetic disks, and memory cards. Software and data used to practice embodiments of the present invention, e.g., ensemble modeling engine 110, quarterly weight update program 112, weekly forecast issuance program 114, and database 116, can be stored on such portable computer readable storage media and can be loaded onto persistent storage 408 via I/O interface(s) 412. I/O interface(s) 412 also connect to a display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for revenue forecasting, the method comprising:
retrieving, by one or more computer processors, revenue forecast data;
processing, by the one or more computer processors, the revenue forecast data through one or more revenue forecast models;
retrieving, by the one or more computer processors, one or more weights associated with a performance of the one or more revenue forecast models, wherein each of the one or more weights corresponds to one of the one or more revenue forecast models;
applying, by the one or more computer processors, one of the one or more weights associated with the performance of the one or more revenue forecast models to each of a corresponding processed revenue forecast data; and
computing, by the one or more computer processors, a weighted average revenue forecast.

2. The method of claim 1, wherein retrieving one or more weights associated with each of the one or more revenue forecast models further comprises:
retrieving, by the one or more computer processors, actual revenue data for a specified time period;
retrieving, by the one or more computer processors, past processed revenue forecast data for the specified time period;
determining, by the one or more computer processors, a performance of the one or more revenue forecast models for the specified time period; and
calculating, by the one or more computer processors, one or more weights associated with the performance of the one or more revenue forecast models.

3. The method of claim 2, wherein determining the performance of the one or more revenue forecast models for the specified time period further comprises:
comparing, by the one or more computer processors, the actual revenue data for the specified time period to the past processed revenue forecast data for the specified time period; and
determining, by the one or more computer processors, based, at least in part, on a difference between the actual revenue data for the specified time period and the past processed revenue forecast data for the specified time period, an accuracy of the past processed revenue forecast data, wherein a higher accuracy is associated with a smaller difference.

4. The method of claim 3, wherein calculating one or more weights associated with the performance of the one or more revenue forecast models further comprises assigning, by the one or more computer processors, a highest weight to the revenue forecast model with a highest accuracy.

5. The method of claim 1, further comprising:
responsive to applying one of the one or more weights associated with the performance of the one or more revenue forecast models to each of the corresponding processed revenue forecast data, determining, by the one or more computer processors, whether the processed revenue forecast data from one or more of the one or more revenue forecast models is an outlier;
responsive to determining the processed revenue forecast data from one or more of the one or more revenue forecast models is an outlier, setting, by the one or more computer processors, a weight corresponding to the outlier to zero; and
re-scaling, by the one or more computer processors, the one or more weights of the one or more revenue forecast models which are not outliers such that a sum of the one or more weights equals one.

6. The method of claim 1, wherein revenue forecast data includes data generated in at least the following time intervals: quarterly, monthly, weekly, and daily.

7. The method of claim 1, further comprising, responsive to processing the revenue forecast data through one or more revenue forecast models, storing, by the one or more computer processors, the processed revenue forecast data.

8. The method of claim 1, further comprising:
responsive to computing the weighted average revenue forecast, storing, by the one or more computer processors, the weighted average revenue forecast; and
generating, by the one or more computer processors, a weighted average revenue forecast report.

9. A computer program product for revenue forecasting, the computer program product comprising:
one or more computer readable storage media and program instructions stored on the one or more computer readable storage media, the program instructions comprising:
program instructions to retrieve revenue forecast data;
program instructions to process the revenue forecast data through one or more revenue forecast models;
program instructions to retrieve one or more weights associated with a performance of the one or more revenue forecast models, wherein each of the one or more weights corresponds to one of the one or more revenue forecast models;
program instructions to apply one of the one or more weights associated with the performance of the one or more revenue forecast models to each of a corresponding processed revenue forecast data; and
program instructions to compute a weighted average revenue forecast.

10. The computer program product of claim 9, wherein program instructions to retrieve one or more weights associated with each of the one or more revenue forecast models further comprises:
program instructions to retrieve actual revenue data for a specified time period;
program instructions to retrieve past processed revenue forecast data for the specified time period;
program instructions to determine a performance of the one or more revenue forecast models for the specified time period; and
program instructions to calculate one or more weights associated with the performance of the one or more revenue forecast models.

11. The computer program product of claim 10, wherein program instructions to determine the performance of the one or more revenue forecast models for the specified time period further comprises:
program instructions to compare the actual revenue data for the specified time period to the past processed revenue forecast data for the specified time period; and
program instructions to determine, based, at least in part, on a difference between the actual revenue data for the specified time period and the past processed revenue forecast data for the specified time period, an accuracy of the past processed revenue forecast data, wherein a higher accuracy is associated with a smaller difference.

12. The computer program product of claim 11, wherein program instructions to calculate one or more weights associated with the performance of the one or more revenue forecast models further comprises program instructions to assign a highest weight to the revenue forecast model with a highest accuracy.

13. The computer program product of claim 9, further comprising:
responsive to applying one of the one or more weights associated with the performance of the one or more revenue forecast models to each of the corresponding processed revenue forecast data, program instructions to determine whether the processed revenue forecast data from one or more of the one or more revenue forecast models is an outlier;
responsive to determining the processed revenue forecast data from one or more of the one or more revenue forecast models is an outlier, program instructions to set a weight corresponding to the outlier to zero; and
program instructions to re-scale the one or more weights of the one or more revenue forecast models which are not outliers such that a sum of the one or more weights equals one.

14. The computer program product of claim 9, further comprising, responsive to processing the revenue forecast data through one or more revenue forecast models, program instructions to store the processed revenue forecast data.

15. A computer system for revenue forecasting, the computer system comprising:
one or more computer processors;
one or more computer readable storage media;
program instructions stored on the one or more computer readable storage media for execution by at least one of the one or more computer processors, the program instructions comprising:
program instructions to retrieve revenue forecast data;
program instructions to process the revenue forecast data through one or more revenue forecast models;
program instructions to retrieve one or more weights associated with a performance of the one or more revenue forecast models, wherein each of the one or more weights corresponds to one of the one or more revenue forecast models;
program instructions to apply one of the one or more weights associated with the performance of the one or more revenue forecast models to each of a corresponding processed revenue forecast data; and
program instructions to compute a weighted average revenue forecast.

16. The computer system of claim 15, wherein program instructions to retrieve one or more weights associated with each of the one or more revenue forecast models further comprises:
program instructions to retrieve actual revenue data for a specified time period;
program instructions to retrieve past processed revenue forecast data for the specified time period;
program instructions to determine a performance of the one or more revenue forecast models for the specified time period; and
program instructions to calculate one or more weights associated with the performance of the one or more revenue forecast models.

17. The computer system of claim 16, wherein program instructions to determine the performance of the one or more revenue forecast models for the specified time period further comprises:
program instructions to compare the actual revenue data for the specified time period to the past processed revenue forecast data for the specified time period; and
program instructions to determine, based, at least in part, on a difference between the actual revenue data for the specified time period and the past processed revenue forecast data for the specified time period, an accuracy of the past processed revenue forecast data, wherein a higher accuracy is associated with a smaller difference.

18. The computer system of claim 17, wherein program instructions to calculate one or more weights associated with the performance of the one or more revenue forecast models further comprises program instructions to assign a highest weight to the revenue forecast model with a highest accuracy.

19. The computer system of claim 15, further comprising:
responsive to applying one of the one or more weights associated with the performance of the one or more revenue forecast models to each of the corresponding processed revenue forecast data, program instructions to determine whether the processed revenue forecast data from one or more of the one or more revenue forecast models is an outlier;
responsive to determining the processed revenue forecast data from one or more of the one or more revenue forecast models is an outlier, program instructions to set a weight corresponding to the outlier to zero; and
program instructions to re-scale the one or more weights of the one or more revenue forecast models which are not outliers such that a sum of the one or more weights equals one.

20. The computer system of claim 15, further comprising, responsive to processing the revenue forecast data through one or more revenue forecast models, program instructions to store the processed revenue forecast data.
